(19) United States
(12) Patent Application Publication
(10) Pub. No.: US 2015/0140973 A1
(43) Pub. Date: May 21, 2015

(54) SYSTEM AND METHOD FOR ENSURING A CALL IS MADE FROM WITHIN A CALL APPLICATION

(71) Applicant: Talk. to FZC, Ras Al Khaimah (AE)

(72) Inventor: Bhavin Turakhia, Mumbai (IN)

(21) Appl. No.: 14/148,361

(22) Filed: Jan. 6, 2014

(30) Foreign Application Priority Data
Nov. 19, 2013 (IN) 3618/MUM/2013

(51) Int. Cl. H04M 1/725

(52) U.S. Cl. CPC H04M 1/72519
USPC 455/414.1

(57) ABSTRACT

In example embodiments, a system and method for ensuring that a call is made from within a call application is provided. Call details of a call initiated from a device of a user is accessed. A determination is made as to whether a notification is received from the call application on the device of the user. Based on the notification being received from the device of the user, a determination is made as to whether the notification provides an indication that the call was made from within a call application. A notice is provided to the user based on the call being made from outside the call application.

### CROSS-REFERENCE TO RELATED APPLICATION(S)

The present application claims the benefit of priority under 35 U.S.C. §119 to Indian Application No. 3618/MUM/2013, filed on Nov. 19, 2013, which is incorporated herein by reference in its entirety.

### FIELD

The present disclosure relates generally to network communication, and in a specific example embodiment, to ensuring a call is made from within a call application.

### BACKGROUND

Typically, when a mobile device, such as a smartphone, is used to conduct a call, a dialer application that was provided by the manufacturer of the mobile device at manufacturing time (also referred to a “native call application”) is used by default. However, the native call application may be unable to provide certain functionalities or advantages that a carrier-branded call application or third party call application may be able to provide. While some companies may partner with the manufacturer to lock the mobile device or substitute the default dialer, a problem with this approach is that the carrier or third party has to preemptively strike a deal with all manufacturers. This may be unrealistic.

### BRIEF DESCRIPTION OF DRAWINGS

Various ones of the appended drawings merely illustrate example embodiments of the present invention and cannot be considered as limiting its scope.

FIG. 1 is a diagram illustrating an example environment in which embodiments of a system for managing contacts in a network may be implemented.

FIG. 2 is a block diagram illustrating an example embodiment of a user device.

FIG. 3 is a block diagram illustrating an example embodiment of a service provider system.

FIG. 4 is a block diagram illustrating an example embodiment of a carrier system.

FIG. 5 is a flow diagram of an example method for determining whether a call is made from within a call application.

FIG. 6 is a flow diagram of another example method for determining whether the call is made from within the call application.

FIG. 7 is a flow diagram of an example method for managing a call that is attempted from outside the call application.

FIG. 8 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Example embodiments described herein provide systems and methods for ensuring that a call is initiated from within a call application. In example embodiments, an indication of a call made from a device of a user is received by a carrier system. Call details for the call may be accessed from the carrier system by a service provider system. In some embodiments, the service provider and the carrier system maybe one and the same. A determination is made as to whether a notification is received by the service provider system from the device of the user. Based on the notification being received from the device of the user or based on information contained within the notification, a determination is made as to whether the notification provides an indication that the call was initiated from within a call application. In some embodiments, the determination is made by comparing the information contained within the notification with the call details accessed from the carrier system. In some cases, if the call is not initiated from within the call application, the call may be dropped. In other cases, the call may be conducted from outside of the call application, and a notice may be provided to the user based on the call being initiated from outside the call application. This notice may inform the user of the advantages of initiating the call from within the call application.

The call application may be preferred because the call application can provide functionalities or advantages over a native or other application on the device. For example, the use of the call application may provide a special rate on all international calls such that whenever the user tries to make an international call, the call is first attempted over the Internet as opposed to making a direct public switched telephone network (PSTN) call. If the call over the Internet is not available, then the system may fall back to a PSTN call. There may be other functionalities or capabilities that are provided by the call application that allows the user to reduce their costs and accordingly, costs for a carrier or service provider that is providing the call connection service to the user.

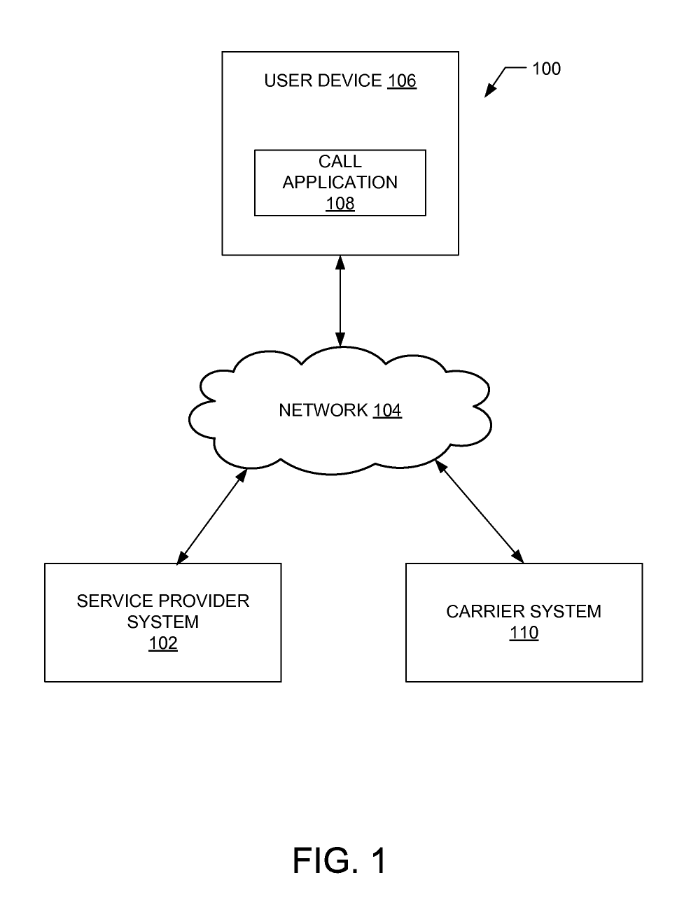

With reference to FIG. 1, a diagram illustrating an example environment 100 in which embodiments of a system for ensuring a call is initiated from within a call application is provided. The environment 100 comprises a service provider system 102 coupled via a network 104 (e.g., the Internet, wireless network, cellular network, or a Wide Area Network (WAN)) to a user device 106. The user device 106 is associated with a user that has downloaded or otherwise has an installed call application 108 on their user device 106 that corresponds to the service provider system 102. The user device 106 may also have a native application for providing call service. Thus, the user device 106 may comprise multiple applications for use in making a call, and the user has an option to use either. The user device 106 may comprise a mobile phone, smartphone, laptop, tablet, or any other communication device that a user may utilize to store, access, or operate the call application 108 in order to make a call.

The call application 108 comprises a piece of functionality on the user device 106 that provides functions or operations that allow the user of the user device 106 to make a call. By using the call application 108, the user may be provided enhanced call features or discounted calls over calls made using a native application on the user device 106 (e.g., an application provided by the manufacturer of the user device 106). In some embodiments, the service provider system 102 may provide the call application 108 to the user device 106 (e.g., provide a downloadable version of the service application, electronically send the service application to the user device 106, or physically send to the user via a storage medium such as a CD ROM).

Regardless of whether a call is initiated from within the call application 108 or outside of the call application 108, the call made by the user device 106 may be routed through a carrier system 110. The carrier system 110 may comprise a phone carrier or entity that has the capability to connect the user at the user device 106 to an intended callee via a calling network (e.g., PSTN, Internet).

It is noted that the environment 100 shown in FIG. 1 is exemplary. Alternative embodiments may comprise any number of user devices 106 in the environment 100. Furthermore, the service provider system 102 may be embodied within or otherwise owned by the carrier system 110 or vice versa. Accordingly, the functions and components of the service provider system 102 may be combined with the carrier system 110 in some embodiments.

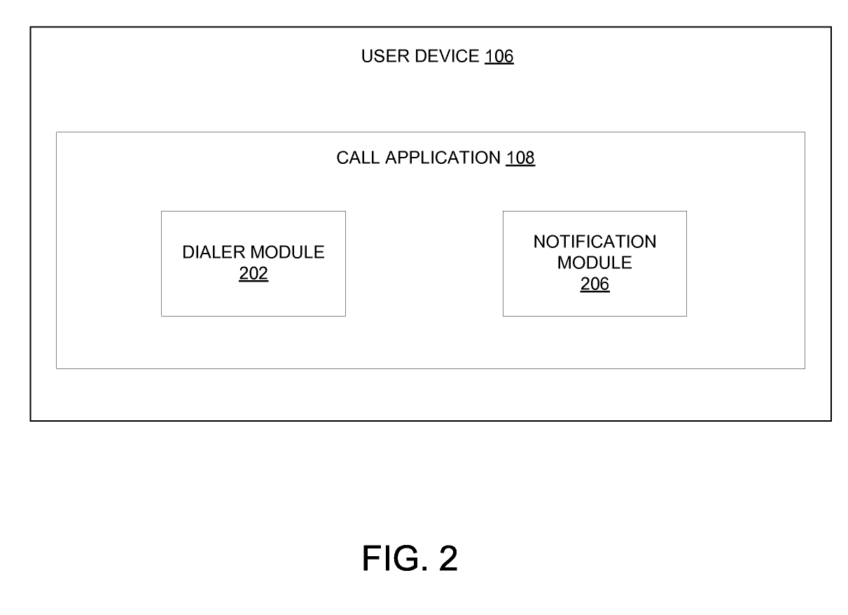

Referring now to FIG. 2, a block diagram illustrating an example embodiment of the user device 106 is shown. The user device 106 is shown having the call application 108 installed thereon. The call application 108 may provide enhanced calling functionality and services to the user device 106. The call application 108 also provides data to the service provider system 102 or the carrier system 110 that enables them to determine whether a call attempt or a conducted call (collectively referred to as a “call”) by the user device 106 was initiated from within (e.g., using) the call application 108. Accordingly, the call application 108 may comprise a dialer module 202 and a notification module 206. It is noted that the call application 108 may comprise other modules not pertinent to example embodiments that are not shown or discussed.

The dialer module 202 may direct call attempts to the carrier system 110. Upon activation of the call application 108, the dialer module 202 allows the user of the user device 106 to dial a number of a callee or select a number for the callee from stored contact information (e.g., from an address book). Once the number is entered and a call initiated (e.g., selecting a “dial” or “talk” button), the dialer module 202 attempts to place the call via the carrier system 110. In some embodiments, the dialer module 202 attempts to first route the call via the Internet, or via other lower cost routes, failing which it routes the call via the default carrier system 110.

The notification module 206 provides a notification of call details of one or more calls or one or more events to the service provider system 102. The call details may include the number dialed, call start time, call end time, duration, or any suitable combination thereof. Any call initiated from within the call application 106 should be known to the call application 108 and may be provided in a notification to the service provider system 102 or the carrier system 110. However, in some embodiments, calls initiated from outside the call application 108 may or may not be explicitly known to the call application 108. In some embodiments, the notification module 206 may provide the notification in substantially real-time. That is, the notification may be sent prior to or with a call attempted by the dialer module 202 or prior to or with any events recorded by the call application 108. In other embodiments, the notification may be provided at a later time (e.g., after a call has concluded or after an event is recorded). For example, the notification module 206 may send a batch notification comprising a plurality of calls initiated or a plurality of events over a predetermined period of time (e.g., last 6 hours) or when requested by the service provider system 102. For example, the notification module 206 may receive a wake up notice at a scheduled time to send the notification (e.g., a notice instructing the call application 108 to periodically send the notification in response to a scheduled task or via a push message).

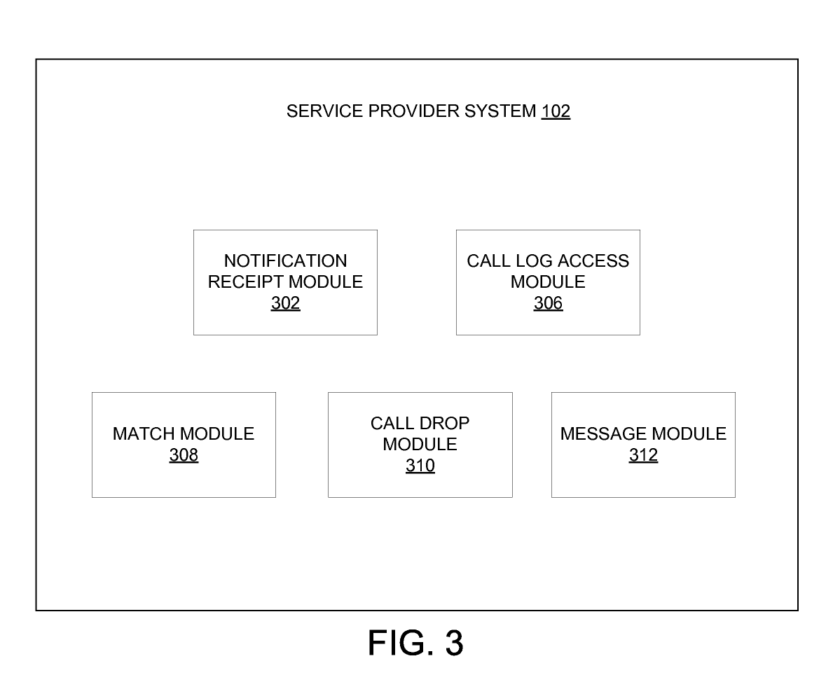

Referring now to FIG. 3, the service provider system 102 is shown in more detail. In example embodiments, the service provider system 102 may comprise one or more servers that provide call functionalities and services to users of the call application 108. To enable these functionalities and services, the service provider system 102 may comprise a notification receipt module 302, a call log access module 306, a match module 308, a call drop module 310, and a message module 312. The service provider system 102 may comprise other components not pertinent to example embodiments that are not shown or discussed. Furthermore, alternative embodiments may comprise more, less, or other modules for ensuring calls are initiated from within the call application 108. Some functions of the modules may be combined or divided into two or more further modules.

The notification receipt module 302 receives or otherwise obtains the notification sent by the user device 106. In one embodiment, the notification comprises call details of calls initiated by the user device 108 using the call application 108. The call details may include, for example, the number dialed, the start time, the end time, and duration of each call. In some embodiments, the notification is sent in substantially real-time with occurrence of the call and start time of a call may be considered to be the time the notification was received.

In another embodiment, the notification may comprise events performed within the call application 108 and a time each event occurred. Events may include, for example, opening the call application 108, accessing or using a dialer provided by the dialer module 202, and selecting a send button. Events may also comprise exit events such as exiting the call application 108 or canceling a call before it is connected to the callee. In some embodiments, the notification may indicate an event but not a time. In these embodiments, the notification is sent in substantially real-time with the occurrence of the event. Therefore, the notification receipt module 302 may associate a time that the notification was received to the event in the notification and use that time in determining whether a call was made within a predetermined time period of the time.

In another embodiment, the notification may comprise call details of calls initiated by the user device 108 outside the call application 108. The call details may include, for example, the number dialed, the start time, the end time, and duration of each call. In some embodiments, the notification is sent in substantially real-time with occurrence of the call and start time of a call maybe considered to be the time the notification was received.

The notification may be received in substantially real-time as a call is being made or may be received in a batch format. A batch notification may be received when a certain number of calls have been made or at/after a predetermined time. For example, a component of the service provider system 102 may send a notice to the notification module 206 that may wake up the call application 108 and trigger the call application 108 to send the notification.

The call log access module 306 accesses call details or a call log maintained at the carrier system 110. In example embodiments, since all calls are routed through the carrier system 110, the carrier system 110 maintains a record of all call attempts initiated by the user device 106. The call details maintained by the carrier system 110 may include details such as, for example, dialed number, call start time, call end time, duration of the call, or any suitable combination thereof. The call log may comprise one or more entries of one or more calls received at the carrier system.

The match module 308 performs a comparison between the notification received from the user device 106 and the call details of calls received by the carrier system 110 that corresponds to the user device 106 (e.g., a number or identifier of the user device 106) to determine whether each call was initiated from within the call application 108. In embodiments where the notification comprises call details of one or more calls made using the call application 108, the match module 308 compares the call details in the notification to call details of calls received by the carrier system 110 to find matches in the call details. If a match is discovered, then the matching call is determined to be initiated from within the call application 108. However, if no match is determined (e.g., no notification received or matching a call received by the carrier system), then the call is deemed to be initiated from outside the call application 108.

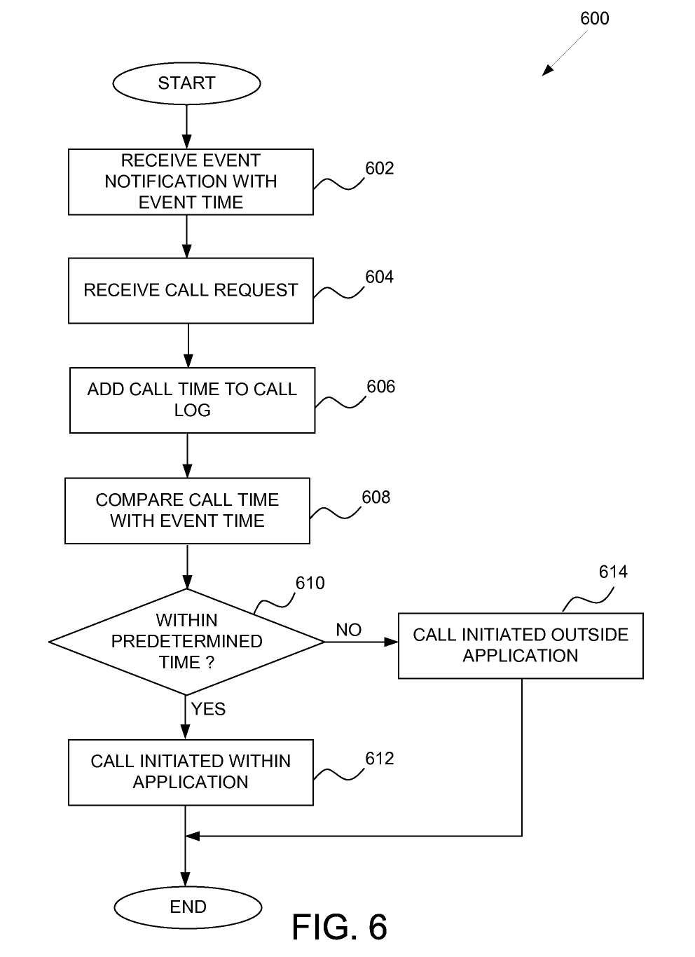

In embodiments where the notification comprises events, the match module 308 attempts to determine whether a call received by the carrier system 110 was made within a predetermined threshold amount of time of an event that occurred at the call application 108. In some cases, a call occurring within the predetermined threshold amount of time of an event may indicate that the call was initiated using the call application 108. Alternatively if a call is made outside of the predetermined threshold amount of time of an event, then the call may be determined to be initiated from outside the call application 108. Furthermore, in other embodiments, a call occurring within a predetermined threshold amount of time after an exit event may indicate that the call was initiated from outside the call application 108 (e.g., using a native application of the user device 106). These embodiments will be discussed in more detail in connection with FIG. 6 below.

The call drop module 310 determines whether a call should be dropped. In some embodiments, when the match module 308 determines in real-time that the call was initiated from outside the call application 108, the call drop module 310 may instruct the carrier system 110 to drop the call to prevent the call from being initiated from outside the call application 108 (herein referred to a “non-call application”). In some cases, a message may be provided by the message module 312 regarding the dropped call. For example, the message may indicate that the call was dropped and that a future call should be initiated using the call application 108.

In other embodiments, the call initiated from outside the call application 108 may not be dropped, and the user at the user device 106 is allowed to conduct the call using the non-call application. However, the message module 312 may provide a message to the user device 106 indicating that the particular call was initiated outside of the call application 108 and suggest that future calls be initiated using the call application 108.

As such, the message module 312 manages sending messages to the user device 106 regarding calls that were not made using the call application 108. The message may be sent, for example, using SMS, Internet, or e-mail or may comprise sending a USSD message or playing an audio message live on or after the call (e.g., voicemail). In some embodiments, the message module 312 may be located at the carrier system 110.

In some embodiments, a determination of whether a predetermined number of messages within a particular time period has been sent is made (e.g., five messages within 48 hours). The message module 312 may refrain from providing any further messages in response to the predetermined number of messages being exceeded.

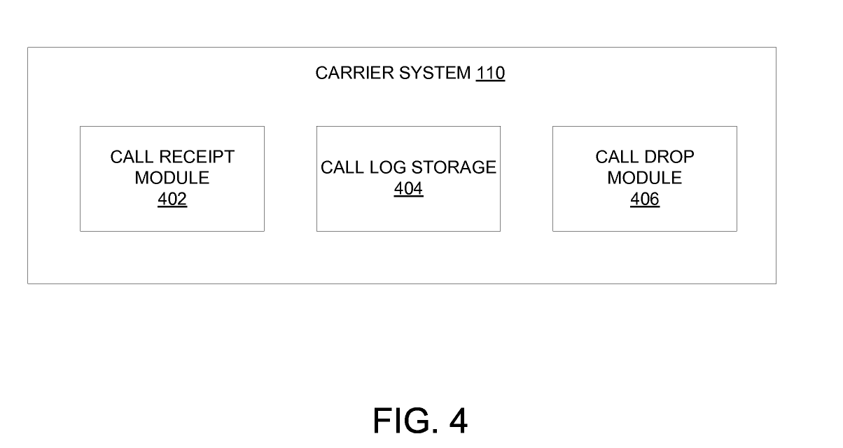

FIG. 4 is a block diagram illustrating an example embodiment of the carrier system 110. The carrier system 110 manages call connections, dropping of calls, and in some cases, providing messages during a call. Accordingly, the carrier system 110 may comprise a call receipt module 402, a call log storage 404, and a call drop module 406. It is noted that the carrier system 110 may comprise other modules not pertinent to example embodiments that are not shown or discussed.

The call receipt module 402 receives the call request from the user device 106. In some cases, the call receipt module 402 may automatically connect the call indicated in the call request. The call receipt module 402 may also create a log entry in the call log storage 404 that records details of the call request. The details may include, for example, one or more of a start time of call, an end time of call, a duration of call, and a number dialed.

The call drop module 406 may end or drop a call based on receiving instructions from the call drop module 310 of the service provider system 102 to drop the call. In example embodiments, the call drop module 310 of the service provider system 102 may determine that a call is being initiated from outside the call application 108 and provides instructions to the call drop module 406 of the carrier system 110 to either drop the call (if the call is already connected) or to not connect the call indicated in the call request. In some cases, the call drop module 406 may provide an audio message to the user informing the user the reason for dropping the call.

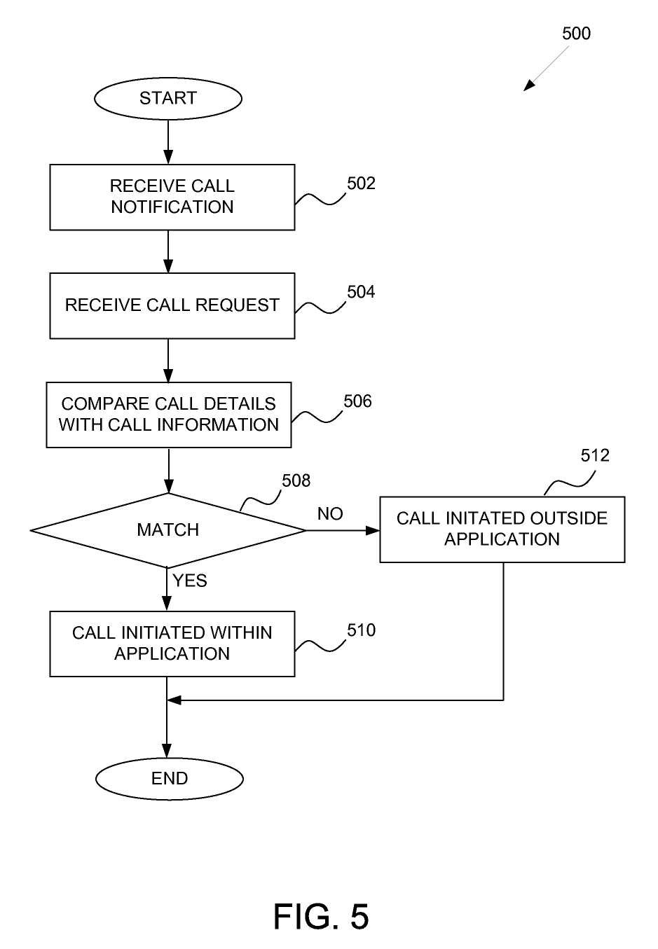

FIG. 5 is a flow diagram of an example method 500 for determining whether a call is made from within the call application 108. The operations of the method 500 may be performed by a combination of the service provider system 102 and the carrier system 110 which may be embodied on one or more servers. In operation 502, the notification receipt module 302 receives a notification from the user device 106. In the present embodiment, the notification comprises call details of calls initiated using the call application 108. In example embodiments, the notification may be sent over a network (e.g., Internet), or SMS request, or email to the notification receipt module 302.

In operation 504, a call request is received from the user device 106 by the call receipt module 402 of the carrier system 110. The call request may include a number of the callee and an identifier of the user device 106 (e.g., a number of the user device 106). In an embodiment where calls are connected regardless of whether it was initiated from within the call application 108 or outside of the call application 108, the call receipt module 402 attempts to connect the call. A log entry may be created in a call log storage 404 by the call receipt module 402 to record receipt of the call request or the call attempt. The log entry may include one or more of a start time of call, an end time of call, a duration of call, and a number dialed.

The call details in the notification are compared to the entries in the call log for the user device 106 from the call log storage 404 in operation 506. In an example embodiment, the call log access module 306 accesses a call log in the call log storage 404 of the carrier system 110 to obtain information corresponding to the entries. If an entry in the call log matches the call details in the notification in operation 508, then the call corresponding to that entry is determined to be initiated from within the call application 108 in operation 510. However, if an entry in the call log does not match any call details in the notification in operation 508, then the call corresponding to that entry is determined to be initiated from outside the call application 108 in operation 512. In example embodiments, a match is determined based on, for example, a call start time or end time being within a threshold of a time indicated by the notification, a call duration is within a threshold of a time indicated by the notification, and a called number is the same in both the entry and the notification.

It is noted that the operations of the method 500 may be performed in a different order. For example, the call request may be received (operation 504) prior to receiving the call notification (operation 502). This may occur, for example, when the notification is provided with a batch of calls over a period of time.

Furthermore, some of the operations of the method 500 may be optional or modified or other operations added. For example, the call may be dropped or not connected if a match is not determined in operation 510 which indicates that the call is initiated from outside the call application 108.

FIG. 6 is a flow diagram of another example method 600 for determining whether the call is initiated from within the call application 108. The operations of the method 600 may be performed by a combination of the service provider system 102 and the carrier system 110 which may be embodied on one or more servers. In operation 602, the notification receipt module 302 receives a notification from the user device 106. In the present embodiment, the notification is an event notification that comprises a listing of one or more events and their corresponding times that occurred within the call application 108. In example embodiments, the notification may be sent as a web request, or SMS request, or email to the notification receipt module 302.

In operation 604, a call request is received from the user device 106 by the call receipt module 402 of the carrier system 110. The call request may include a number of the callee and an identifier of the user device 106 (e.g., a number of the user device 106). In an embodiment where calls are connected regardless of whether it was initiated from within the call application 108 or outside of the call application 108, the call receipt module 402 attempts to connect the call. A log entry may be created in a call log storage 404 by the call receipt module 402 to record receipt of the call request or the call attempt in operation 606 that may include a time of the call request.

The entries in the call log for the user device 106 may be accessed by the service provider module 102 and compared to the event notification to determine if a call occurred within a predetermined time window (e.g., within five minutes) before or after a time recorded for an event indicated in the notification in operation 608. If an entry in the call log storage 404 occurred within the predetermined time window of an event in operation 610, then the call corresponding to that entry is determined to be initiated from within the call application 108 in operation 612. However, if an entry in the call log storage 404 occurs outside of the predetermined time window of an event in operation 610, then the call corresponding to that entry is determined to be initiated from outside the call application 108 in operation 614. The predetermined time window may vary based on the event. For example, call requests received within 1 minute before or after accessing a dialer function or within 5 minutes of opening the call application maybe deemed to be initiated from within the call application.

It is noted that the operations of the method 600 may be performed in a different order. For example, the call request may be received (operation 604) prior to receiving the event notification (operation 602). This may occur, for example, when the notification is provided over a period of time and may indicate one or more events.

Furthermore, some of the operations of the method 600 may be optional or modified. For example, creation of a log entry (operation 606) that is used to compare to events in the event notification in real-time may not be needed. That is, timing of events may be compared to the call request that is received in operation 604 in real-time. Additionally in these embodiments, the call may be dropped or not connected if the call is not within the predetermined time of an event occurring within the call application 108 in operation 610 which indicates that the call is initiated from outside the call application 108.

It is further noted that while events discussed above are with respect to call-initiating events (e.g., opening a dialer, opening the call application 108), alternatively, the events may be exit events. In embodiments where the events are exit events, if a call is made within a predetermined time after the exit event, then the call may be determined to be initiated from outside of the application.

While example embodiments provide a determination that a call is not initiated from inside the call application 108 when no notification is received from the user device 106, in some cases, this determination may be suspended when no connectivity is detected with the user device 106. For example, the user device may be out of service area and cannot send an SMS, e-mail, or a web request. In these cases, the service provider system 102 may not assume that a call received at the carrier system 110 was not initiated from within the call application and hence the service provider system 102 may not provide instructions to drop the call and may not send a notice to the user. The service provider system 102 may determine that the user device 106 has no connectivity, for example, by sending a “ping” message to the user device 106 and awaiting a response. If no response is received, then the user device 106 may be deemed to have no connectivity.

Furthermore, while example embodiments have been discusses whereby the notifications received from the user device 106 comprise call details for calls that are initiated from within the call application 108, alternative embodiments may contemplate embodiments where the notification may comprise call details for calls initiated from outside the call application 108 as well. Similarly, alternative embodiments may contemplate embodiments where the notification may comprise events of other applications that occur outside of the call application. For example, some user devices 106 may have an operating system that allows the call application 108 to detect activities, such as calls, that are initiated outside of the call application 108. This is a direct notification of a call or event that is initiated from outside of the call application 108.

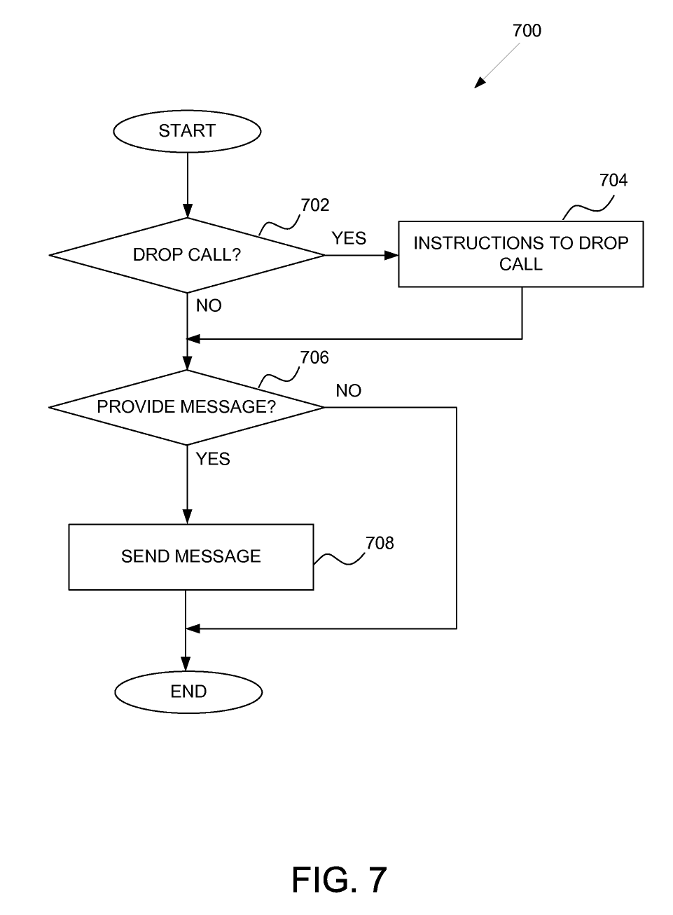

FIG. 7 is a flow diagram of an example method 700 for managing a call that is attempted from outside the call application 108. When a call is determined to be initiated from outside the call application 108 (e.g., operations 414, operation 514), the service provider system 102 may instruct the carrier system 110 to drop the call, provide messages to the user of the user device 106, or a combination of both. As such in operation 702, a determination is made as to whether to drop the call that is determined in real-time to be initiated from outside of the call application 108. Some service provider systems 102 may determine to automatically drop the call, while others may have conditions for dropping the call, and others still will permit the call to proceed from outside of the call application 108. The conditions may be based on, for example, the number of calls initiated by the user from outside the call application 108 exceeding a predetermined threshold. If a determination is made to drop the call in operation 702, then instructions to drop the call are provided to the carrier system 110 in operation 704. In some embodiments, prior to dropping the call an audio message maybe played to the user informing the user the reason for dropping the call.

In operation 706, a determination is made as to whether to provide a message to the user of the user device 106 that is attempting or has made a call from outside of the call application 108. If a message should be sent, then in operation 708 the message module 312 generates and sends the message to the user. In some cases, the message may indicate that the call was dropped and that a future call should be made using the call application 108. Alternatively, the message module 312 may provide a message to the user device 106 indicating that a particular call was initiated outside of the call application 108 and suggest that future calls be initiated using the call application 108. The message may be sent, for example, using SMS, e-mail, USSD, voicemail, or a real-time audio message played on the call. In some embodiments, a determination of whether a predetermined number of messages within a particular time period has been sent is made. The message module 312 may refrain from providing any further messages in response to the predetermined number of messages being exceeded.

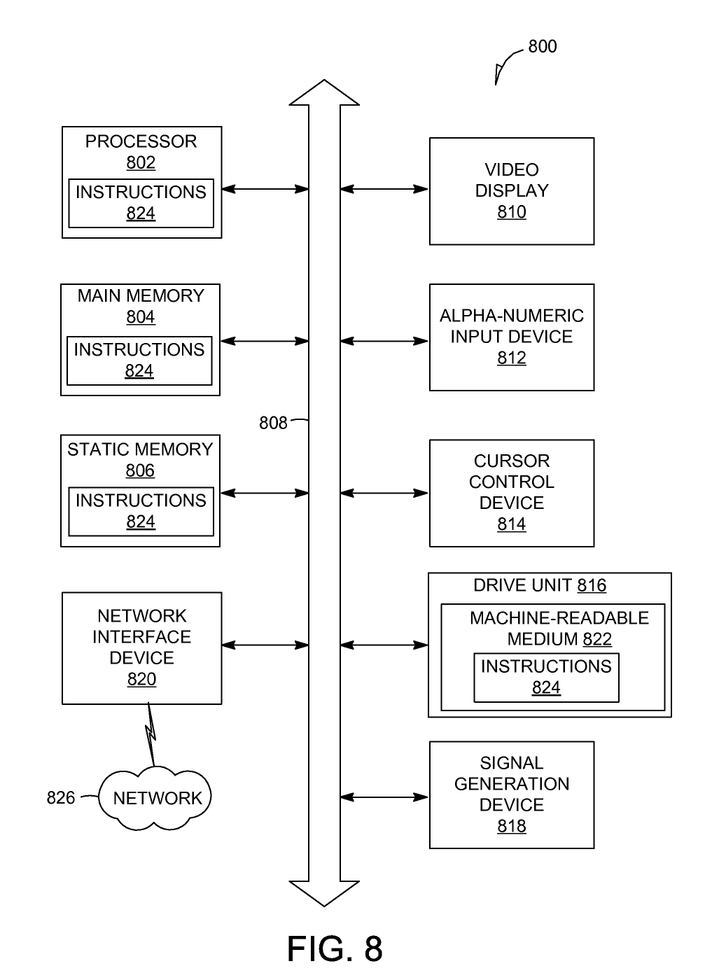

FIG. 8 is a block diagram illustrating components of a machine 800, according to some example embodiments, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system and within which instructions 824 (e.g., software, a program, an application, an applet, an app, or other executable code) for causing the machine 800 to perform any one or more of the methodologies discussed herein may be executed. In alternative embodiments, the machine 800 operates as a standalone device or may be connected (e.g., networked) to other machines. In a networked deployment, the machine 800 may operate in the capacity of a server machine or a client machine in a server-client network environment, or as a peer machine in a peer-to-peer (or distributed) network environment. The machine 800 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 824, sequentially or otherwise, that specify actions to be taken by that machine. Further, while only a single machine is illustrated, the term “machine” shall also be taken to include a collection of machines that individually or jointly execute the instructions 824 to perform any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The machine 800 may further include a graphics display 810 (e.g., a plasma display panel (PDP), a light emitting diode (LED) display, a liquid crystal display (LCD), a projector, or a cathode ray tube (CRT)). The machine 800 may also include an alpha-numeric input device 812 (e.g., a keyboard), a cursor control device 814 (e.g., a mouse, a touchpad, a trackball, a joystick, a motion sensor, or other pointing instrument), a storage unit 816, a signal generation device 818 (e.g., a speaker), and a network interface device 820.

The storage unit 816 includes a machine-readable medium 822 on which is stored the instructions 824 embodying any one or more of the methodologies or functions described herein. The instructions 824 may also reside, completely or at least partially, within the main memory 804, within the processor 802 (e.g., within the processor's cache memory), or both, during execution thereof by the machine 800. Accordingly, the main memory 804 and the processor 802 may be considered as machine-readable media. The instructions 824 may be transmitted or received over a network 826 via the network interface device 820.

As used herein, the term “memory” refers to a tangible machine-readable medium able to store data temporarily or permanently and may be taken to include, but not be limited to, random-access memory (RAM), read-only memory (ROM), buffer memory, flash memory, and cache memory. While the tangible machine-readable medium 822 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 800), such that the instructions, when executed by one or more processors of the machine (e.g., processor 802), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Furthermore, the tangible machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

The instructions 824 may further be transmitted or received over a communications network 826 using a transmission medium via the network interface device 820 and utilizing any one of a number of well-known transfer protocols (e.g., HTTP). Examples of communication networks include a local area network (LAN), a wide area network (WAN), the Internet, mobile telephone networks, POTS networks, and wireless data networks (e.g., WiFi and WiMAX networks). The term “transmission medium” shall be taken to include any intangible medium that is capable of storing, encoding, or carrying instructions for execution by the machine, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Although an overview of the inventive subject matter has been described with reference to specific example embodiments, various modifications and changes may be made to these embodiments without departing from the broader scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising:
accessing call details of a call initiated from a device of a user;
determining whether a notification is received from a call application on the device of the user;
based on the notification being received from the device of the user, determining, using a hardware processor, whether the notification provides an indication that the call was initiated from within the call application; and
based on the call being initiated from outside the call application, providing a notice to the user.

2. The method of claim 1, wherein providing the notice to the user comprises at least one selection from the group consisting of dropping the call, sending an SMS, sending an email, sending a USSD message, sending a notification message, and playing an audio message.

3. The method of claim 1, wherein the notification indicates an event initiated within the call application and a time of the event, wherein the determining whether the notification provides the indication that the call was initiated from within the call application is based on whether the time of the event is within a threshold time of a time of the call.

4. The method of claim 3, wherein the event comprises at least one selection from the group consisting of opening the call application, exiting the call application, and performing a task within the call application, the task comprising at least one selection from the group consisting of entering digits, dialing a number, opening a dialer, and pressing a dial button.

5. The method of claim 3, wherein the time of the event is contained within the notification or is determined based on a time the notification was received by the server.

6. The method of claim 1, further comprising determining that the call is initiated from within the call application based on the notification comprising call information of an application call that is initiated from within the call application, the call information of the application call matching the call details of the call.

7. The method of claim 6, wherein the call information of the application call comprises at least one selection from the group consisting of digits dialed, call duration, and a time the application call was initiated.

8. The method of claim 6, wherein a time of the application call is contained within the notification or is determined based on a time the notification was received by the server.

9. The method of claim 6, wherein the call information of the application call is determined to match the call details of the call based on the call information and call details being within a threshold difference.

10. The method of claim 1, further comprising not concluding that the call was initiated from outside the calling application based on not receiving the notification from the user device of the user while the user device is not connected to the Internet.

11. The method of claim 10, further comprising determining whether the user device is connected to the Internet by pushing a message to the user device and awaiting a successful delivery confirmation.

12. The method of claim 1, wherein the determining whether the notification provides the indication that the call was initiated from outside the calling application comprises determining that the notification comprises an outside user activity performed outside the call application and a time of the outside user activity, wherein the time of the outside user activity is within a threshold time of a time of the call.

13. The method of claim 1, wherein the notification comprises call information of a non-application call that is initiated from outside the call application, wherein the non-application call is determined to be initiated from outside the call application based on the call information of the non-application call in the notification matching the call details of the call.

14. The method of claim 1, further comprising instructing the call application to periodically send the notification in response to a scheduled task or via a push message.

15. The method of claim 1, wherein the notification is received via SMS, Internet, or email.

16. The method of claim 1, further comprising:
determining whether a predetermined number of notices within a time period has been sent; and
refraining from providing the notice in response to the predetermined number of notices within the time period being sent.

17. A non-transitory machine-readable medium in communication with at least one processor, the non-transitory machine-readable medium storing instructions which, when executed by the at least one processor of a machine, cause the machine to perform operations comprising:
accessing call details of a call initiated from a device of a user;
determining whether a notification is received from a call application on the device of the user;
based on the notification being received from the device of the user, determining whether the notification provides an indication that the call was initiated from within the call application; and
based on the call being initiated from outside the call application, providing a notice to the user.

18. The non-transitory machine-readable medium of claim 17, wherein the notification indicates an event initiated within the call application and a time of the event, wherein the determining whether the notification provides the indication that the call was initiated from within the call application is based on whether the time of the event is within a threshold time of a time of the call.

19. The non-transitory machine-readable medium of claim 17, wherein the operations further comprise determining that the call is initiated from within the call application based on the notification comprising call information of an application call that is initiated from within the call application, the call information of the application call matching call details of the call.

20. A system comprising:
a hardware processor of a machine;
a call log access module configured to access call details of a call initiated from a device of a user;
a notification receipt module configured to determine whether a notification is received from a call application on the device of the user;
a match module configured to determine, using the hardware processor, whether the notification provides an indication that the call was initiated from within the call application based on the notification being received from the device of the user; and
a module configured to provide a notice to the user based on the call being initiated from outside the call application.

21. The system of claim 20, wherein the module to provide the notice comprises a call drop module that instructs dropping the call based on the call being made from outside the call application.

22. The system of claim 20, wherein the module to provide the notice comprises a message module to provide a message indicating the call was made from outside the call application.
